(19) United States
(12) Patent Application Publication
(10) Pub. No.: US 2008/0210449 A1
(43) Pub. Date: Sep. 4, 2008

(54) Post drivers

(76) Inventors: Craig Russell, Auckland (NZ); James Ernest Fairbrother, Auckland (NZ)

Correspondence Address: JACOBSON HOLMAN PLLC, 400 SEVENTH STREET N.W., SUITE 600, WASHINGTON, DC, 20004, US

(21) Appl. No.: 11/892,961

(22) Filed: Aug. 28, 2007

(30) Foreign Application Priority Data
Mar. 1, 2007 (NZ) 553592
Aug. 3, 2007 (NZ) 560375

(51) Int. Cl. B23Q 5/00

(52) U.S. Cl. 173/151

(57) ABSTRACT

A post driver with a rising mast (optionally with a hinging shield for the hammer or monkey/post interaction zone) where a mechanical advantage on movement of the hammer or monkey, (as the mast moves) arises from a carriaged pulley interposed between ram assemblies.

The present invention relates to driving apparatus (eg; for piles, posts or the like) and assemblies for inclusions in such apparatus.

The present invention also relates to the use of any such assemblies and apparatus.

Our KING HITTER™ range of post driving apparatus is well known. It involves a vehicle carried manipulatable mast that has slidingly engaged therewith a driving monkey or hammer (“monkey”) able to be uplifted (under the action of a rope, cable or chain (hereinafter “cable or the like”) passing over at least one mast carried pulley or sprocket) and dropped so as to achieve the drive effect.

Various energies of drive are possible with the same monkey depending on the height to which it is lifted prior to being allowed to drop.

For higher energies and momentum for the same monkey weight, a taller mast to act as a guide for the monkey and to carry the cable, chain or other pulley, sprocket or the like system is required.

A vehicle carried tall mast (usually supported by the three point linkage of a vehicle and/or controllable as to angle relative to a frame supported directly from the three point linkage of a vehicle) can give rise to one or more of the following:
a difficulty of garaging
a difficulty where post driving is required under the canopy of a row of trees or other structure(s),
a greater toppling moment of consequence in steep country.

The present invention recognizes that it is possible with a telescopic mast arrangement to provide for higher energies and momentum or such energy and momentum required with a lower height assembly that only occasionally is fully raised. It is to improve driving apparatus of that type that the present invention, in one aspect, is directed.

It is an alternative or further object to provide an alternative to driving apparatus having an always tall mast structure.

It is an alternative or further object to provide a lean or low weight or material(s) post driver but which none the less provides a mechanical advantage and/or is telescopic.

In an aspect the invention is a pile or post (“post”) driving apparatus comprising or including

a vehicle carried or carriable structure or assembly (“primary structure”),

a mast structure or assembly (“secondary structure”) guidable by the primary structure,

a driving weight (“monkey”) guidable by the secondary structure,

a carriaged pulley, sprocket or like means (“pulley”) rectilinearly moveable relative to each of said primary and secondary structures (albeit optionally guided by one or the other, or both),

a lower ram assembly from the carriage of the carriaged pulley down to a lower region of the primary structure,

an upper ram assembly from the carriage of the carriaged pulley up to an upper region of the secondary structure,

at least two pulleys, sprockets or the like (“pulley(s)”) carried by an upper region of the secondary structure, and

a flexible connection

(1) from the carriage and/or part of the upper ram assembly fixed relative thereto

(2) via one of said upper pulleys,

(3) via the carriaged pulley,

(4) via at least one other upper pulley,

(5) to the monkey;

the arrangement being such that at the upper end of the travel of the monkey guided by the secondary structure both said ram assemblies have been extended and the carriaged pulley is raised above the position(s) it assumes when the lower ram assembly is less extended.

In another aspect the invention is a pile or post (“post”) driving apparatus having

both a primary and secondary structure, and

a driving weight (“monkey”) guidable by the secondary structure,

wherein the secondary structure can in use define a mast that can move vertically relative to the primary structure,

and wherein a positionable pulley (or the equivalent) acts on the cable (or the equivalent) that supports the monkey and that positionable pulley is positioned between two ram assemblies, one ram assembly to raise, hold or lower the secondary structure relative to the axis of the positionable pulley and one ram assembly to raise, hold or lower the axis of the positionable pulley relative to the primary structure.

Preferably in either aspect there is a mechanical advantage as hereinafter described. Preferably that advantage is 4 to 1 but others can be employed with different pulley numbers.

Preferably the primary structure includes a mount or support structure mountable from a vehicle, eg; by a three point linkage. Otherwise the primary structure indirectly is mountable from a vehicle (eg; via a support).

Examples of support include those of our KING HITTER™ range of drivers.

It can also or instead be as disclosed in our published WO2005/098144 hereby here included by way of reference.

Such a support is an assembly having

a rail, mounts for engaging the lower two linkage arms of a three point linkage so as to support the rail laterally of the three point linkage arrangement, and a carriage to run on said rail and carrying or adapted to carry, at least in part, or to be, at least in part, the primary structure.

The carriage travel on the rail is greater than 200 mm.

The position of the carriage along the rails can be adjusted and/or controlled eg; by a ram and cylinder. Preferably the primary structure itself is directly or indirectly to link to the upper linkage of a said three point linkage arrangement.

The primary support can have a spindle to be received in a journalled manner by the carriage to allow tilt laterally of the vehicle axis relative to the carriage.

In another aspect the invention is a post or pile driving apparatus comprising or including

a primary structure,

a secondary structure guidably mounted relative to the primary structure so as to be able to telescope upwardly with respect thereto,

a drive between the primary structure and said secondary structure so as (A) to cause uplifting of the secondary structure relative to the primary structure and (B) to cause and/or to allow lowering of the secondary structure relative to said primary structure,

a driving monkey supported by said secondary structure, and

a connection between said driving monkey and the primary structure at least in part by a cable, chain or other like linkage whereby a mechanical advantage/disadvantage exists so that raising of the secondary structure relative to the primary structure, under the action of the drive, will lead to the uplifting of the driving monkey relative to the primary structure by a greater distance than does any particular point of the secondary structure;

wherein a shield articulates, or is adapted to articulate, relative to said primary structure to move between a position shielding a zone of interaction between said driving monkey and a post or pile to be driven thereby.

Preferably said apparatus is also apparatus as earlier defined.

Preferably there is, in addition, articulated or other shielding apparatus for controls for said drive whereby access to said controls is denied from at or adjacent said zone of interaction between said driving monkey and a said post or pile unless the shielding for such interaction zone is in place protecting such zone.

Preferably there is a linkage between the shield for said interaction zone and the shield for said controls.

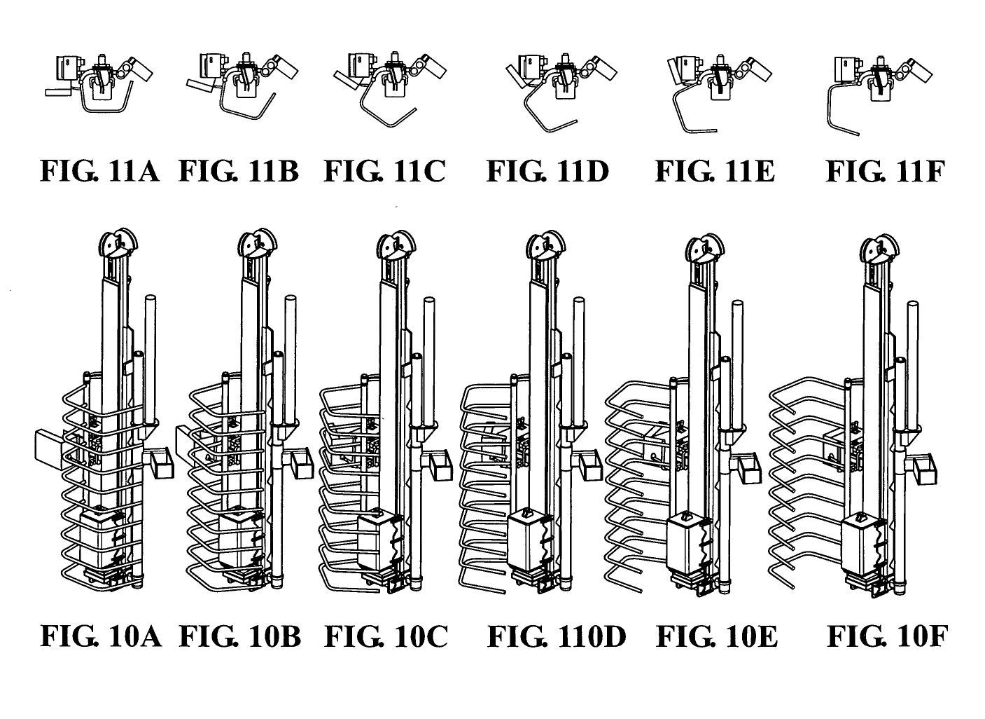

Preferably the apparatus is substantially as herein described with reference to any one or more of FIGS. 10A to 13 of the accompanying drawings.

In a further aspect the present invention consists in post or pile driving apparatus of a kind having a mast (extendible or non-extendible eg; telescopic or non-telescopic) and having a monkey able to be raised and lowered relative thereto responsive to controls, wherein a shield articulates, or is adapted to articulate, relative to said mast, or at least part of the support thereof, to move between a position shielding a zone of interaction between said monkey and a post or pile to be driven thereby, and/or wherein such a shield co-acts with shielding apparatus for said controls whereby access to said controls is denied from at or adjacent said zone of interaction between said monkey and a said post or pile unless the shielding for such interaction zone is in place protecting such zone.

In any of the embodiments preferably said shielding for said interaction zone is such that it can feed through (at least from its distal regions remote from its articulation) into an existing fence line.

Preferably said apparatus as substantially as previously described.

In another aspect the invention is a post or pile driving apparatus comprising or including

a primary structure,

a secondary structure guidably mounted relative to the primary structure so as to be able to telescope upwardly with respect thereto,

a drive between the primary structure and said secondary structure so as (A) to cause uplifting of the secondary structure relative to the primary structure and (B) to cause and/or to allow lowering of the secondary structure relative to said primary structure,

a driving monkey supported by said secondary structure,

a connection between said driving monkey and the primary structure at least in part by a cable, chain or other like linkage whereby a mechanical advantage/disadvantage exists so that raising of the secondary structure relative to the primary structure under the action of the drive will lead to the uplifting of the driving monkey relative to the primary structure by a greater distance than does any particular point of the secondary structure,

wherein a shield articulates relative to said primary structure adapted to move between a position shielding a zone of interaction between said driving monkey and a post or pile to be driven thereby.

Optionally there is in addition articulated shielding apparatus for controls for said drive whereby access to said controls is denied from at or adjacent said zone of interaction between said driving monkey and a said post or pile unless the shielding for such zone is in place protecting such zone.

Preferably there is a linkage between the shield for said zone and the shield for said controls.

Preferably the apparatus is substantially as herein described with reference to any one or more of FIGS. 10A to 13 of the accompanying drawings.

Preferably said apparatus is also apparatus as earlier defined.

In yet a further aspect the present invention consists in a method of driving an article (such as a post but not necessarily a post) which involves operative use of apparatus in accordance with the present invention.

As used herein “comprising” can mean consisting only of or including or having.

As used herein the term “and/or” means “and” or “or”, or both.

As used herein the term “(s)” following a noun includes, as might be appropriate, the singular or plural forms of that noun.

As used herein “primary structure” includes any fixed, adjustable or other structure. Preferably it includes a mount for three point mounting and optionally it allows some articulation or movement of the associated secondary structure and some at least of the primary structure relative to the mount.

Preferably it guides movement of the tertiary structure.

As used herein “secondary structure” includes a rising mast of any form.

As used herein “monkey” includes any hammer supportable by the flexible connection (eg; cable), with or without guidance from, or with or without being captive to, the rising mast or secondary structure, but it may be a monkey guidable as a carriage on the secondary structure which acts as the hammer.

As used herein “link” includes any tension link, etc. (eg; “flexible connection”) having at least some flexibility as might be used between pulley or the equivalent blocks.

As used herein “mast” includes beams, as well as other structures or forms.

“Pulley” or “block” as used herein is that member or assembly appropriate for a link connection eg; could be a block of pulleys or a single pulley, or could be of sprocket and/or pulley forms, etc.

Reference herein to “mechanical advantage” refers to the effect arising from the use of a flexible connection or link with multiple pulleys, blocks or the like such that there is a greater monkey movement when being, say, raised than the extension of either or both of the ram assemblies.

As used herein “ram assembly” preferably but not necessarily refers to fluid actuated extendable assemblies. Alternatives to a preferred hydraulic system are gas, solenoid, or the like driven equivalents.

In still another aspect the invention is apparatus as previously defined but where one of the ram assemblies is instead a member or assembly of fixed length or fixed lengths but there can if desired be substitution of that member or assembly of fixed length(s) by a said ram assembly.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

Preferred forms of the present invention will now be described with reference to the accompany drawings in which

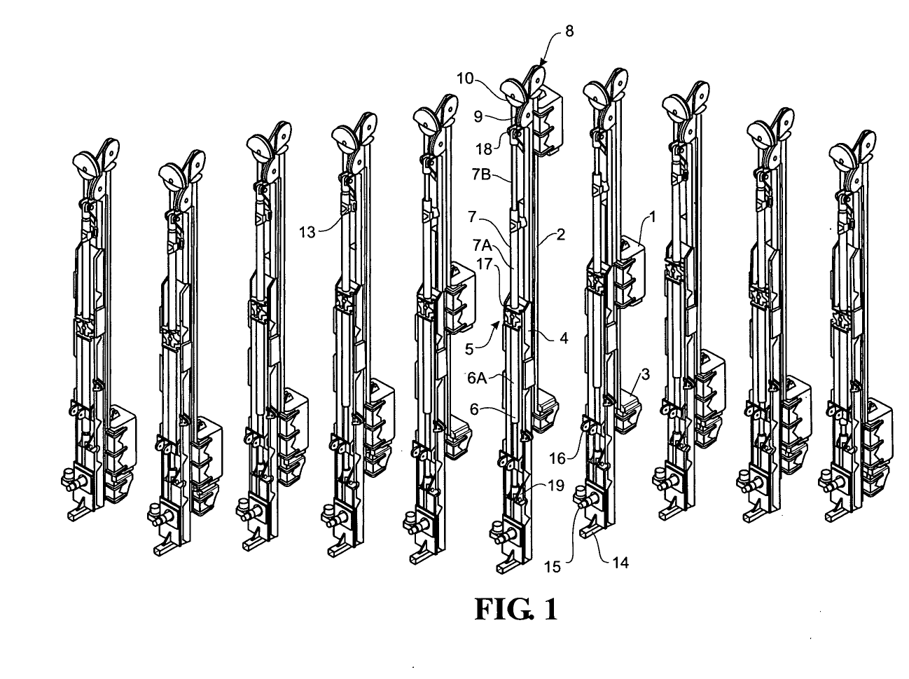

FIG. 1 is a sequence of perspective drawings from one direction of a preferred form of the post driving apparatus of the present invention showing that from a contracted form with neither ram assembly extended through a range of dispositions including where it is fully extended back to the condition on the left,

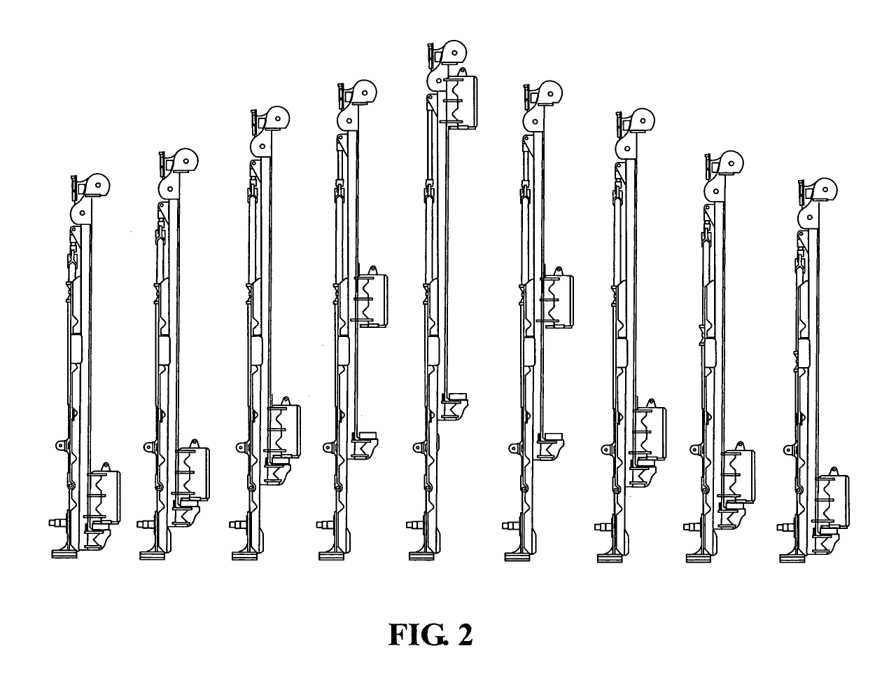

FIG. 2 is a side elevational sequence corresponding to that of FIG. 1,

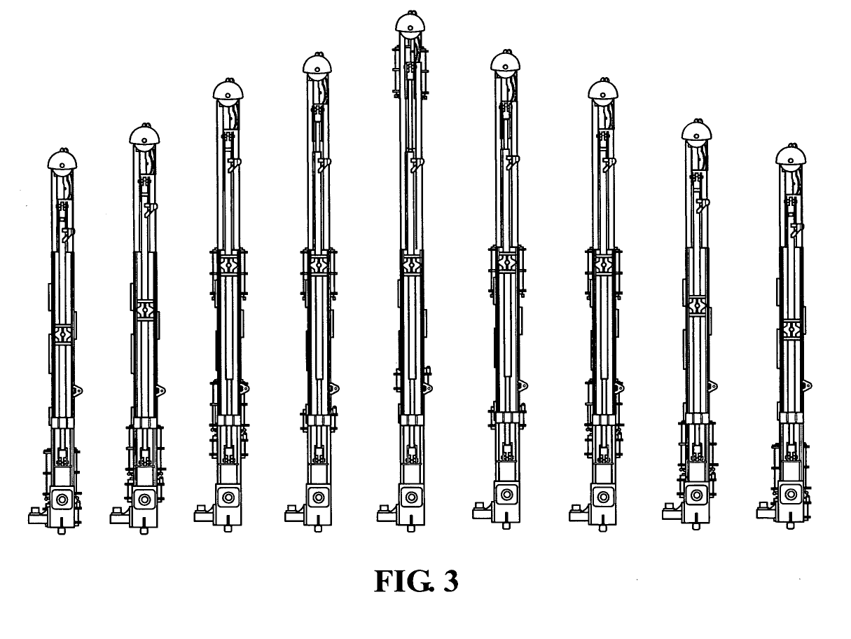

FIG. 3 is a similar sequence to that of FIGS. 1 and 2 but from still a different direction,

FIG. 4 shows yet another further such sequence but from still a different direction,

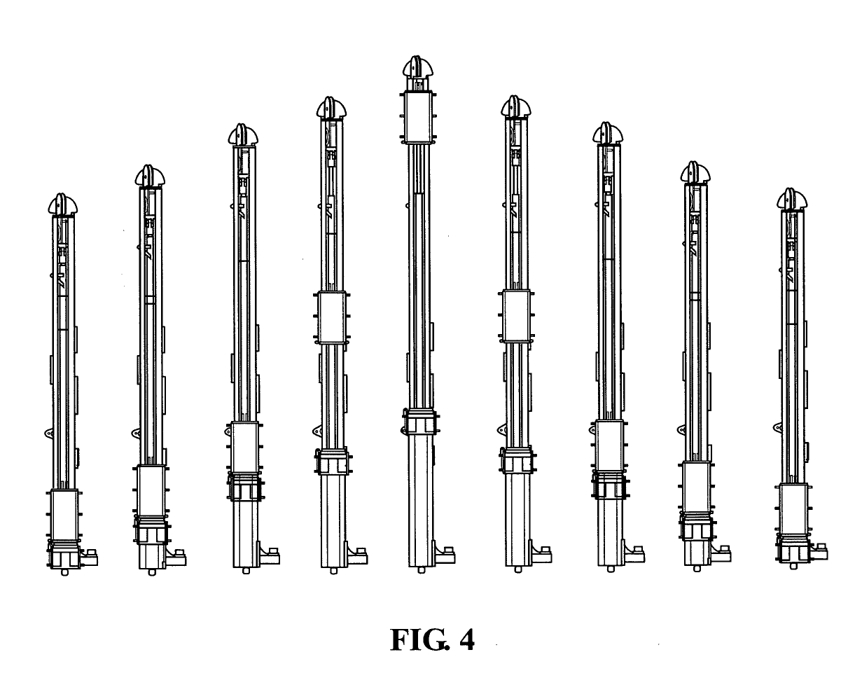

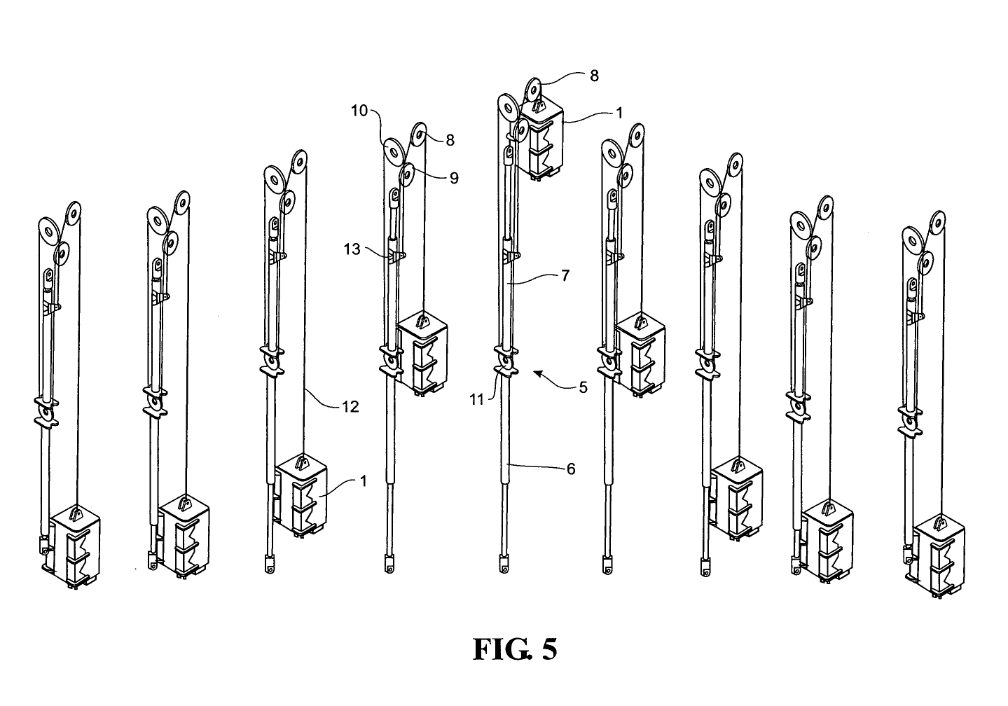

FIG. 5 shows for such a sequence as in FIGS. 1 through 4 the relationship of the interposed pulley, (i.e. that carried in a fixed relationship preferably between the cylinders of two oppositely acting ram assemblies) and the association of one of the cylinders (the uppermost) with one end of the flexible connection via a first top end pulley, via the interposed pulley, and via at least one (preferably two so as to allow the offset) pulley(s) down to the monkey, thereby to provide a mechanical advantage of 4:1, and having the capability with the contractability and extendibility of each ram assembly (preferably under separate hydraulic inputs and controls therefor) of taking the monkey and the mast height (i.e.; the height of the secondary structure relative to the first structure through the range of positions shown whilst at the same time allowing uplift etc and dropping of the monkey),

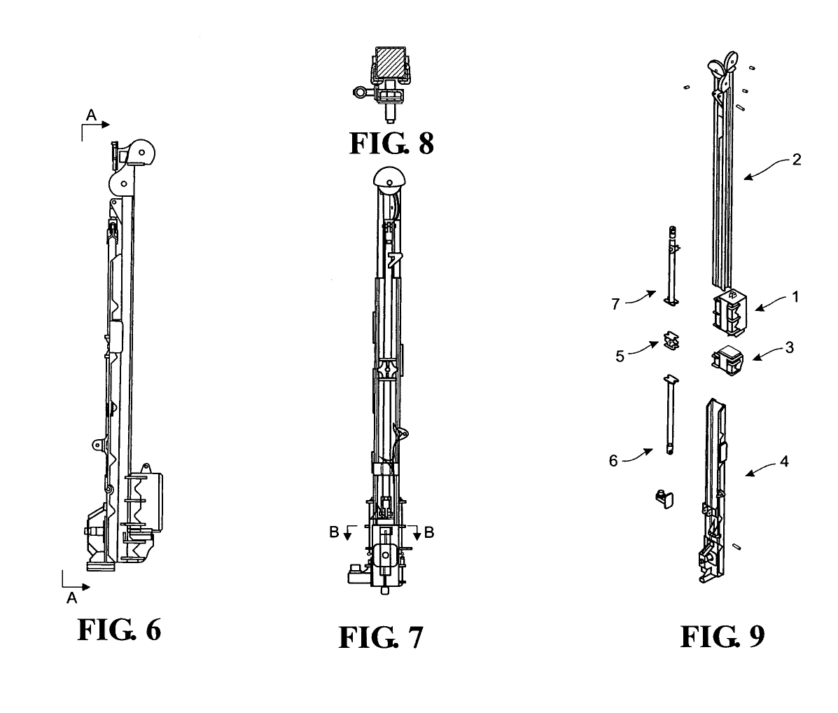

FIG. 6 is a side elevational view of the post driver of the preceding drawings with the monkey resting on the post cap and not showing the cable,

FIG. 7 is a view AA of the post driver of FIG. 6,

FIG. 8 is a section looking in the direction BB showing how each of the monkey and the post cap are slidably captive on the secondary member or mast and how in turn the mast or secondary member is slidably associated with the primary structure,

FIG. 9 is a perspective exploded view (minus the cable and hydraulic conduits of the assembly),

FIGS. 10A through 10F show from a shielding condition of the zone between the monkey and a post (the post not being shown) the fully shielded condition but with the controls for the drive available through to the unshielded condition for such zone but with the controls being shielded, there being a link between the two shields,

FIGS. 11A through 11F show from above the arrangement whereby the respective shields move relative to each other through the conditions as depicted in perspective in FIGS. 10A through 10F,

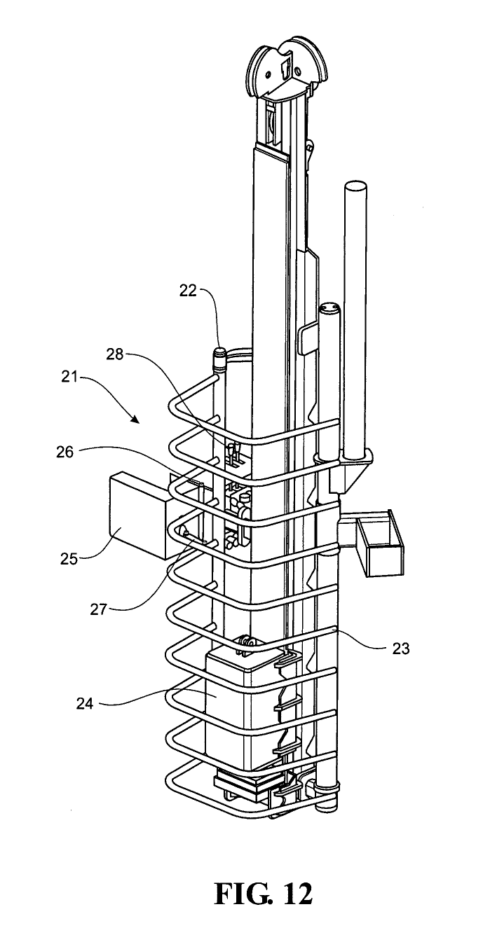

FIG. 12 is an enlarged view of the apparatus as in the condition as in FIG. 10A, and

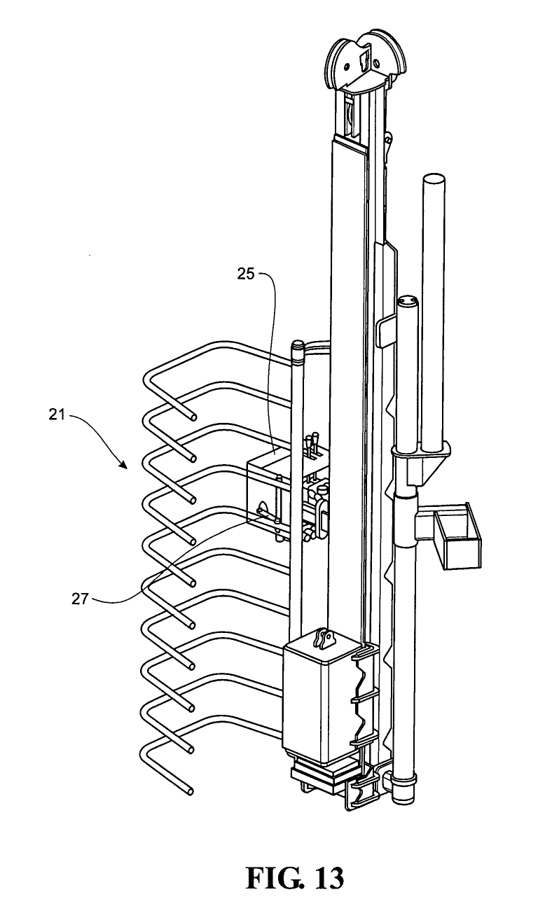

FIG. 13 is a view of the apparatus of FIGS. 10A to 12 but when in the condition as in FIG. 10F.

In the attached drawings hydraulic conduits will not be shown. A person skilled in the art will appreciate how they are to be included. Moreover in FIGS. 6 through 9 for clarity the cable is not shown.

In the preferred form of the present invention the arrangement is as shown with respect to FIGS. 1 through 9 as described. The main structural components are those shown in FIGS. 6 and 7.

As can be seen a monkey 1 is provided that is captive to and is guidably slidable relative to a mast 2 which is the preferred form of the secondary structure. That mast is telescopically slidable on, in or in association with, and is captive to, the primary structure 4.

The component 3 is a cap for association with the upper end of a post or pile to be driven, it preferably is also captive and slidably guidable on the mast 2.

The height of the mast 2 relative to the primary structure 4 is controlled by a lower ram assembly 6 and an upper ram assembly 7 acting in concert to control the height of a pulley assembly 5 whose pulley 11 acts as the lowermost turn around of the flexible connector (preferably a cable) 12.

The cable 12 is linked from the bracket 13 of the cylinder of the upper ram assembly 7 and extends therefrom (A) over pulley 10 carried on the mast (B) down around the pulley 11 (which is of adjustable height under the action of ram assembly 6) (C) upwardly over pulley 8, (D) preferably via the offset rollover pulley 9 (E) to the monkey 1.

Such an arrangement of pulleys provides a 4:1 mechanical advantage.

The actuation preferably of the hydraulic rams has the effect of taking the collection of pulleys 8, 9 and 10 upwardly and downwardly within limits determined by the aggregation of the distance between each end of each ram assembly. The lower ram assembly controls the height of the pulley 11 and the upper ram assembly 7 controls the height of the pulleys 8, 9 and 10 relative to the pulley 11.

As can be seen the primary structure has a footing sleeve 14, a pivot providing mount 15 that can act into a positioning structure from the lower arms of a three point linkage (eg; as in our WO 2005/098144) and an upper bracket arrangement 16 that can control inclination relative to that lower mount.

Persons skilled in the art will appreciate how with such an arrangement, ram assembly 7 with its sleeve 7A and its piston 7B are connected at 17 to the carriage or mount or box 5 of the pulley 11 and at the other end pivotally to a bracket structure 18. Similarly the top end of the sleeve 6A of the lower ram assembly can be fixed to 5 whilst the other end is fixed to the bracket 19 by appropriate pivot. See exploded drawing of FIG. 9.

Preferably the linking of the ram assemblies 6 and 7 through the interposed pulley arrangement is such as to provide rigidity so that no guiding of the member 5 is required by either the primary structure 4 or the mast 2 although there can be, if desired, some measure of support from one or other.

As can be seen from FIGS. 6 through 9 sub-assemblies and/or individual components can be brought together from the exploded form as shown in FIG. 9 to provide an assembly as shown in FIG. 6 through 8 and which, when provided with appropriate hydraulic conduits, it is appropriately mounted, has the cable, etc, can pile or post drive through the modes shown in FIGS. 1 through to 5.

Lower cost versions of the same product can be made on the same production line substituting, if desired, a rigid link for the ram assembly 6. Such a lower cost option which would have the assembly 5 of the pulley 11 at a fixed height, could nonetheless be retroactively converted should the needs of a farmer, contractor, or other user change.

Persons skilled in the art will appreciate how such an arrangement provides for a lightweight rising mast arrangement, lower weight for transportation (i.e. with the mast, monkey and cap down), and reduced material requirements.

FIG. 10A through FIG. 13 show how apparatus, as in FIGS. 1 to 9, can be protected in order to meet Australian requirements and such other requirements as may be introduced elsewhere. It should be appreciated however that the telescopic apparatus shown in FIG. 10A onwards could instead be telescopic apparatus as disclosed in our earlier New Zealand patent specification 538154 or could indeed be a non-telescopic post driver of any of the KING HITTER™ series previously referred to.

In the embodiment shown however it can be seen that there can be a progression, one way or the other, between the conditions shown in FIGS. 10A to 10F and 11A to 11F.

The preferred skeletal shield 21 (of fingers) articulates on a substantially vertical axis 22 so that its distal regions 23 can thread into an existing fence line yet still provide some protection for a user standing on the ground outside of the shield 21, the interaction zone between the monkey 24 (when raised and being dropped) being somewhere behind the shield 21 and above the post to be driven.

Of course above the shield 21 there can be an interaction zone but it is not one where there is likely to be any actual interposition of an operator, or parts of an operator, between the monkey 24 and the post.

Also preferably mounted on an articulating axis is a shield 25 which rotates about a pivot axis 26 (preferably but not necessarily also at least substantially vertical). Shown in FIGS. 12 and 13 is a linkage 27 pivoted at each end respectively to the member 25 and part of the shield 21 such that movement to and from the conditions as shown in FIGS. 10A through 11F result, (ie; when in a condition as in FIG. 12) in the hydraulic or other controls being accessed, by a user and operated but they cannot when the shield 21 is open as in FIG. 13, the shield 25 preventing access to switching or other means which enables operation of the levers 28.

In addition to any such shielding, multiple controls can be required to be synchronisely operated, or operated in close serial operation, in order to achieve desired outcomes. Moreover, if desired, a bleed can be provided to reduce the rate of fall of the monkey if the monkey is to be lowered when this shielding is not fully closed.

Persons skilled in the art will appreciate how apparatus substantially as described can be used irrespective of whether or not the post driver described is telescopic or not.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

1. A pile or post (“post”) driving apparatus comprising or including
a vehicle carried or carriable structure or assembly (“primary structure”),
a mast structure or assembly (“secondary structure”) guidable by the primary structure,
a driving weight (“monkey”) guidable by the secondary structure,
a carriaged pulley, sprocket or like means (“pulley”) rectilinearly moveable relative to each of said primary and secondary structures (albeit optionally guided by one or the other, or both),
a lower ram assembly from the carriage of the carriaged pulley down to a lower region of the primary structure,
an upper ram assembly from the carriage of the carriaged pulley up to an upper region of the secondary structure,
at least two pulleys, sprockets or the like (“pulley(s)”) carried by an upper region of the secondary structure, and
a flexible connection
(1) from the carriage and/or part of the upper ram assembly fixed relative thereto
(2) via one of said upper pulleys,
(3) via the carriaged pulley,
(4) via at least one other upper pulley,
(5) to the monkey;
the arrangement being such that at the upper end of the travel of the monkey guided by the secondary structure both said ram assemblies have been extended and the carriaged pulley is raised above the position(s) it assumes when the lower ram assembly is less extended.

2. A pile or post (“post”) driving apparatus having
both a primary and secondary structure, and
a driving weight (“monkey”) guidable by the secondary structure,
wherein the secondary structure can in use define a mast that can move vertically relative to the primary structure,
and wherein a positionable pulley (or the equivalent) acts on the cable (or the equivalent) that supports the monkey and that positionable pulley is positioned between two ram assemblies, one ram assembly to raise, hold or lower the secondary structure relative to the axis of the positionable pulley and one ram assembly to raise, hold or lower the axis of the positionable pulley relative to the primary structure.

3. The apparatus of claim 1 wherein there is a mechanical advantage as hereinafter described.

4. The apparatus of claim 3 wherein said mechanical advantage is 4 to 1.

5. The apparatus of claim 1 wherein the primary structure includes a mount or support structure mountable from a vehicle.

6. The apparatus of claim 5 wherein the mounting is to be by a three point linkage.

7. The apparatus of claim 5 wherein said support structure is an assembly having
a rail, mounts for engaging the lower two linkage arms of a three point linkage so as to support the rail laterally of the three point linkage arrangement, and a carriage to run on said rail and carrying or adapted to carry, at least in part, or to be, at least in part, the primary structure.

8. The apparatus of claim 7 wherein the carriage travel on the rail is greater than 200 mm.

9. The apparatus of claim 8 wherein the position of the carriage along the rails can be adjusted and/or controlled eg; by a ram and cylinder.

10. The apparatus of claim 1 wherein the primary structure itself is directly or indirectly to link to the upper linkage of a said three point linkage arrangement.

11. The apparatus of claim 7, wherein the primary support can has a spindle to be received in a journalled manner by the carriage to allow tilt laterally of the vehicle axis relative to the carriage.

12. Post or pile driving apparatus comprising or including
a primary structure,
a secondary structure guidably mounted relative to the primary structure so as to be able to telescope upwardly with respect thereto,
a drive between the primary structure and said secondary structure so as (A) to cause uplifting of the secondary structure relative to the primary structure and (B) to cause and/or to allow lowering of the secondary structure relative to said primary structure,
a driving monkey supported by said secondary structure,
a connection between said driving monkey and the primary structure at least in part by a cable, chain or other like linkage whereby a mechanical advantage/disadvantage exists so that raising of the secondary structure relative to the primary structure under the action of the drive will lead to the uplifting of the driving monkey relative to the primary structure by a greater distance than does any particular point of the secondary structure,
wherein a shield articulates relative to said primary structure adapted to move between a position shielding a zone of interaction between said driving monkey and a post or pile to be driven thereby.

13. The apparatus as claimed in claim 12 wherein there is in addition articulated shielding apparatus for controls for said drive whereby access to said controls is denied from at or adjacent said zone of interaction between said driving monkey and a said post or pile unless the shielding for such zone is in place protecting such zone.

14. The apparatus as claimed in claim 13 wherein there is a linkage between the shield for said zone and the shield for said controls.

15. The apparatus as claimed in claim 12 substantially as hereinbefore described with reference to any one or more of FIGS. 1A to 13 of the accompanying drawings.

16. The apparatus as claimed in claim 12 wherein said apparatus is also apparatus as claimed in any one of claims 1 to 11.

17. A post or pile driving apparatus of a kind having a mast (extendible or non-extendible eg; telescopic or non-telescopic) and having a monkey able to be raised and lowered relative thereto responsive to controls, wherein a shield articulates, or is adapted to articulate, relative to said mast, or at least part of the support thereof, to move between a position shielding a zone of interaction between said monkey and a post or pile to be driven thereby, and/or wherein such a shield co-acts with shielding apparatus for said controls whereby access to said controls is denied from at or adjacent said zone of interaction between said monkey and a said post or pile unless the shielding for such interaction zone is in place protecting such zone.

18. The apparatus of claim 17 wherein said shielding for said interaction zone is such that it can feed through (at least from its distal regions remote from its articulation) into an existing fence line.

19. The method of driving an article (such as a post but not necessarily a post) which involves operative use of apparatus in accordance with claim 1.
